(19) United States
(12) Patent Application Publication
(10) Pub. No.: US 2005/0049339 A1
(43) Pub. Date: Mar. 3, 2005

(54) Flame-retardant thermoset compositions

(75) Inventors: Susanne Knop, Huerth (DE); Martin Sicken, Koeln (DE); Sebastian Hoerold, Diedorf (DE)

Correspondence Address: CLARIANT CORPORATION;INTELLECTUAL PROPERTY DEPARTMENT, 4000 MONROE ROAD, CHARLOTTE, NC, 28205, US

(73) Assignee: Clariant GmbH

(21) Appl. No.: 10/669,973

(22) Filed: Sep. 24, 2003

(30) Foreign Application Priority Data
Sep. 25, 2002 (DE) 10244579.6

(51) Int. Cl. C08K 5/49

(52) U.S. Cl. 524/115

(57) ABSTRACT

The invention relates to flame-retardant thermoset compositions which comprise, as flame retardant, at least one phosphinic salt of the formula (I) and/or a diphosphinic salt of the formula (II) and/or polymers of these 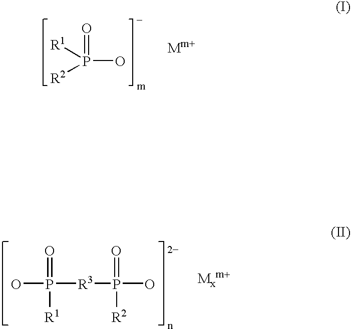 where
R¹,R² are identical or different and are C₁-C₆-alkyl, linear or branched, and/or aryl;
R³ is C₁-C₁₀-alkylene, linear or branched, C₆-C₁₀-arylene, -alkylarylene or -arylalkylene; M is Mg, Ca, Al, Sb, Sn, Ge, Ti, Zn, Fe, Zr, Ce, Bi, Sr, Mn, Li, Na, K and/or a protonated nitrogen base; m is from 1 to 4; n is from 1 to 4; and x is from 1 to 4, and also at least one synergistic component from the substance class of the organic or inorganic phosphorus compounds, and at least one synergistic component from the substance class of the nitrogen compounds. The invention further relates to a process for preparing these flame-retardant thermoset compositions.

The invention relates to flame-retardant thermoset compositions, to a process for their preparation, and to their use.

Components made from thermoset resins, in particular those which have glass-fiber reinforcement, feature good mechanical properties, low density, substantial chemical resistance and excellent surface quality. This and their low cost has led to their increasing use as replacements for metallic materials in the application sectors of rail vehicles, the construction of buildings and air travel.

Unsaturated polyester resins (UP resins), epoxy resins (EP resins) and polyurethanes (PU resins) are combustible and therefore need flame retardants in some applications. Increasing demands in the market for fire protection and for environmental compatibility in products are increasing interest in halogen-free flame retardants, for example in phosphorus compounds or metal hydroxides.

Depending on the application sector, there are different requirements in relation to mechanical, electrical and fire-protection properties. In the rail vehicle sector in particular, fire-protection requirements have recently been made more stringent.

It is known that bromine- or chlorine-containing acid and/or alcohol components are used to formulate flame-retardant unsaturated polyester resins. Examples of these components are hexachloroendomethylene tetrahydrophthalic acid (H ET acid), tetrabromophthalic acid and dibromoneopentyl glycol. Antimony trioxide is often used as a synergist.

In JP-05 245 838 (CA 1993: 672700), aluminum hydroxide, red phosphorus and antimony trioxide are combined with a brominated resin to improve flame retardancy. A disadvantage of bromine- and chlorine-containing resins is that corrosive gases are produced in a fire, and this can result in considerable damage to electronic components, for example to relays in rail vehicles. Unfavorable conditions can also lead to the formation of polychlorinated or brominated dibenzodioxins and furans. There is therefore a requirement for unsaturated polyester resins and unsaturated polyester molding compositions which are flame-retardant and halogen-free.

It is known that unsaturated polyester resins and unsaturated polyester molding compositions may be provided with fillers, such as aluminum hydroxide. The elimination of water from aluminum hydroxide at elevated temperatures gives some degree of flame retardancy. At filler levels of 150-200 parts of aluminum hydroxide per 100 parts of UP resin it is possible to achieve self-extinguishing properties and low smoke density. A disadvantage of systems of this type is their high specific gravity, and attempts are made to reduce this by adding, for example, hollow glass beads [Staufer, G., Sperl, M., Begemann, M., Buhl, D., Düll-Mühlbach, I., Kunststoffe 85 (1995), 4].

PL 159 350 (CA 1995: 240054) describes laminates made from unsaturated polyester resins with up to 180 parts of magnesium hydroxide. However, injection processes, which are extremely important industrially, cannot be used with formulations of this type, due to the high viscosity of the uncured UP resin with the aluminum hydroxide or, respectively, magnesium hydroxide.

The processes described at a later stage below for formulating flame-retardant unsaturated polyester resins likewise have a large number of disadvantages, in particular the requirement for a very high filler content.

To reduce the total filler content, aluminum hydroxide can be combined with ammonium polyphosphate, as described in DE-A-37 28 629. JP-57 016 017 (CA96(22): 182248) describes the use of red phosphorus as a flame retardant for unsaturated polyester resins, and JP-55 094 918 (CA93(24): 22152t) describes the combination of aluminum hydroxide, red phosphorus and antimony trioxide.

PL 161 333 (CA 1994: 632278) achieves low smoke density and low-toxicity decomposition products by using aluminum hydroxide, magnesium hydroxide or basic magnesium carbonate, red phosphorus and, if desired, finely dispersed silica. DE-A-21 59 757 moreover claims the use of melamine and aluminum hydroxide.

Since aluminum hydroxide on its own is not a very effective flame retardant for unsaturated polyester resins or for epoxy resins, combinations with red phosphorus are also proposed, in order to reduce the filler content. A disadvantage here, however, is the red intrinsic color of the product, limiting its use to components with dark pigmentation.

Unsaturated polyester resins are solutions, in copolymerizable monomers, preferably styrene or methyl methacrylate, of polycondensation products made from saturated and unsaturated dicarboxylic acids, or from anhydrides of these, together with diols. UP resins are cured by free-radical polymerization using initiators (e.g. peroxides) and accelerators. The double bonds in the polyester chain react with the double bond in the copolymerizable solvent monomer. The most important dicarboxylic acids for preparing the polyesters are maleic anhydride, fumaric acid and terephthalic acid. The diol most frequently used is 1,2-propanediol. Use is also made of ethylene glycol, diethylene glycol and neopentyl glycol, inter alia. The most suitable crosslinking monomer is styrene. Styrene is fully miscible with the resins and copolymerizes readily. The styrene content in unsaturated polyester resins is normally from 25 to 40%. A monomer which can be used instead of styrene is methyl methacrylate.

Unsaturated polyester resins differ in their chemical and physical properties and in their fire behavior significantly from the similarly named polyesters, which, however, in contrast to the aforementioned unsaturated polyester resins, are thermoplastic polymers. These polyesters are also prepared by completely different processes than those as described in the preceding paragraph for the unsaturated polyester resins. Polyesters can be prepared, for example, by ring-opening polymerization of lactones or by polycondensation of hydroxycarboxylic acids, in which case polymers of the general formula —[O—R—(CO)]—are obtained. The polycondensation of diols and dicarboxylic acids and/or derivatives of dicarboxylic acids produces polymers of the general formula —[O—R¹—O—(CO)—R²—(CO)]—. Branched and crosslinked polyesters can be obtained by polycondensation of alcohols having a functionality of three or more with polyfunctional carboxylic acids.

Unsaturated polyester resins and polyesters are therefore two completely different polymers and represent completely different polymer groups.

Another group of thermosets, epoxy resins, are nowadays used for preparing molding compositions and coatings with a high level of thermal, mechanical and electronic properties.

Epoxy resins are compounds prepared by a polyaddition reaction of an epoxy resin component with a crosslinking (hardener) component. The epoxy resin components used are aromatic polyglycidyl esters, such as bisphenol A diglycidyl ester, bisphenol F diglycidyl ester or polyglycidyl esters of phenol-formaldehyde resins or cresol-formaldehyde resins, or polyglycidyl esters of phthalic, isophthalic or terephthalic acid, or else of trimellitic acid, N-glycidyl compounds of aromatic amines or of heterocyclic nitrogen bases, or else di- or polyglycidyl compounds of polyhydric aliphatic alcohols. Hardeners which are used are polyamines, such as triethylene tetramine, aminoethyl-piperazine or isophoronediamine, polyamidoamines, polybasic acids or anhydrides of these, e.g. phthalic anhydride, hexahydrophthalic anhydride or methyltetrahydrophthalic anhydride, or phenols. The crosslinking may also take place via polymerization using suitable catalysts.

Epoxy resins are suitable for the potting of electrical or electronic components, and for saturation and impregnation processes. The epoxy resins used in electrical engineering are predominantly flame-retardant and used for printed circuit boards or insulators.

In the prior art, epoxy resins for printed circuit boards are currently rendered flame-retardant by including bromine-containing aromatic compounds in the reaction, in particular tetrabromobisphenol A. A disadvantage is that brominated hydrocarbon (a dangerous substance) is liberated in a fire, and this can cause corrosion damage. Under unfavorable conditions, polybrominated dibenzodioxins and furans can also be produced. The use of aluminum hydroxide is completely excluded since it eliminates water when processed.

Fire-protection requirements for electrical and electronic equipment are laid down in specifications and standards for product safety. In the US, fire-protection testing and approval procedures are carried out by Underwriters Laboratories (UL), and UL specifications are nowadays accepted worldwide. The fire tests for plastics were developed in order to determine the resistance of the materials to ignition and flame spread.

The materials have to pass horizontal burning tests (Classification UL 94HB) or the more stringent vertical tests (UL 94V-2, V-1 or V-0), depending on the fire-protection requirements. These tests simulate low-energy ignition sources which occur in electrical devices and to which plastic parts in electrical modules can be exposed.

Surprisingly, it has now been found that salts of phosphinic acids, in combination with a number of synergistic compounds, prove to be effective flame retardants for thermoset resins, such as unsaturated polyester resins or epoxy resins.

Alkali metal salts of phosphinic acids have previously been proposed as flame-retardant additives for thermoplastic polyesters (DE-A-44 30 932). They have to be added in amounts of up to 30% by weight. The salts of phosphinic acids with an alkali metal or with a metal of the second or third main group of the Periodic Table, in particular the zinc salts (DE-A-2 447 727) have also been used to prepare flame-retardant polyamide molding compositions. There is a marked difference in fire performance between thermoplastic polyesters, such as PET and PBT, and thermosetting polyesters, such as unsaturated polyester resins: in a fire thermoplastic materials produce drops of falling material, but thermosetting materials do not melt or produce drops of falling material.

Specifically, the invention relates to flame-retardant thermoset compositions which comprise, as flame retardant, at least one phosphinic salt of the formula (I) and/or a diphosphinic salt of the formula (II) and/or polymers of these 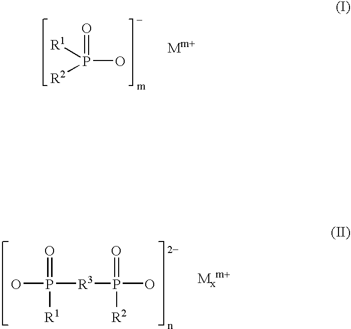
where
R¹,R² are identical or different and are C₁-C₆-alkyl, linear or branched, and/or aryl;
R³ is C₁-C₁₀-alkylene, linear or branched, C₆-C₁₀-arylene, -alkylarylene or
   -arylalkylene;
M is Mg, Ca, Al, Sb, Sn, Ge, Ti, Zn, Fe, Zr, Ce, Bi, Sr, Mn, Li, Na, K and/or a protonated nitrogen base;
m is from 1 to 4;
n is from 1 to 4; and
x is from 1 to 4,
   and also at least one synergistic component from the substance class of the organic or inorganic phosphorus compounds, and at least one synergistic component from the substance class of the nitrogen compounds.

M is preferably calcium, aluminum or zinc.

Protonated nitrogen bases are preferably the protonated bases of ammonia, melamine, triethanolamine, in particular NH₄⁺.

R¹ and R² are preferably identical or different and are C₁-C₆-alkyl, linear or branched, and/or phenyl.

R¹ and R² are preferably identical or different and are methyl, ethyl, n-propyl, isopropyl, n-butyl, tert-butyl, n-pentyl and/or phenyl.

R³ is preferably methylene, ethylene, n-propylene, iso-propylene, n-butylene, tert.-butylene, n-pentylene, n-octylene or n-dodecylene.

Other preferred radicals for R³ are phenylene and naphthylene.

Other preferred radicals for R³ are methylphenylene, ethylphenylene, tert.-butylphenylene, methylnaphthylene, ethylnaphthylene and tert.-butylnaphthylene.

Other preferred radicals for R³ are phenylmethylene, phenylethylene, phenylpropylene and phenylbutylene.

The novel flame-retardant thermoset compositions preferably comprise from 0.1 to 30 parts by weight of at least one phosphinic salt of the formula (I) and/or a diphosphinic salt of the formula (II) and/or polymers of these, and from 0.1 to 100 parts by weight of an organic phosphorus compound, and from 0.1 to 100 parts of a nitrogen compound, per 100 parts by weight of thermoset composition.

The novel flame-retardant thermoset compositions particularly preferably comprise from 1 to 15 parts by weight of at least one phosphinic salt of the formula (I) and/or a diphosphinic salt of the formula (II) and/or polymers of these, and from 1 to 20 parts by weight of an organic phosphorus compound, and from 1 to 20 parts of a nitrogen compound, per 100 parts by weight of thermoset composition.

The organic phosphorus compound is preferably triethyl phosphate, triaryl phosphates, tetraphenyl resorcinaldiphosphate, dimethyl methylphosphonate, and/or its polymers with phosphorus pentoxide, phosphonate ester, (5-ethyl-2-methyl-dioxaphosphorinan-5-yl)methyl methyl methanephosphonate, phosphoric ester, pyrophosphoric ester, alkyphosphonic acids, and/or oxalkylated derivatives of these.

The nitrogen compounds are preferably those of the formulae (III) to (VIII) or mixtures thereof 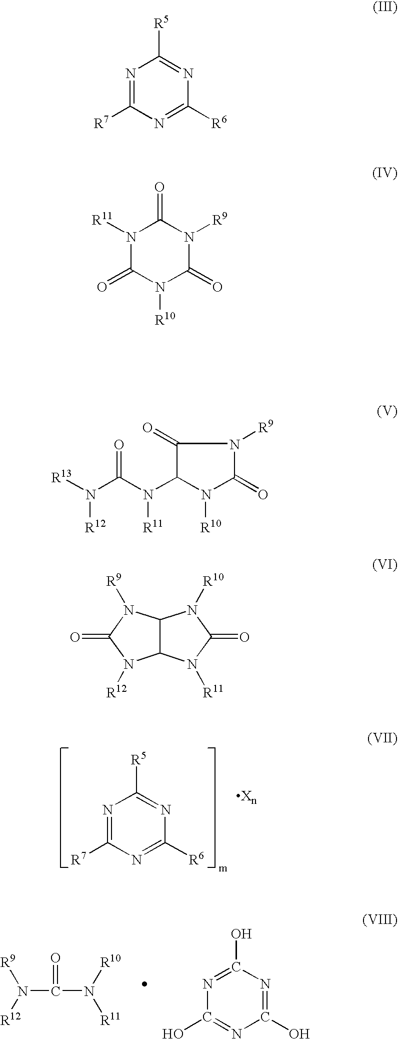
in which R⁵ to R⁷ are hydrogen, C₁-C₈-alkyl, C₅-C₁₆-cycloalkyl or -alkylcycloalkyl, possibly substituted by a hydroxyl or a C₁-C₄-hydroxyalkyl function, C₂-C₈-alkenyl, C₁-C₈-alkoxy, -acyl, -acyloxy, C₆-C₁₂-aryl or -arylalkyl, —OR⁸ and —N(R⁸)R⁹, and also N-alicyclic or N-aromatic, R⁸ is hydrogen, C₁-C₈-alkyl, C₅-C₁₆-cycloalkyl or -alkylcycloalkyl, possibly substituted by a hydroxyl or a C₁-C₄-hydroxyalkyl function, C₂-C₈-alkenyl, C₁-C₈-alkoxy, -acyl, -acyloxy or C₆-C₁₂-aryl or -arylalkyl, R⁹ to R¹³ are the same groups as R⁸ and also —O—R⁸, m and n independently of one another are 1, 2, 3 or 4, X denotes acids which are able to form adducts with triazine compounds (III);
or are oligomeric esters of tris(hydroxyethyl) isocyanurate with aromatic polycarboxylic acids or are nitrogen-containing phosphates of the formulae (NH₄)_{y}H_{3-y}PO₄ and (NH₄PO₃)_{z}, with y being 1 to 3 and z being 1 to 10 000.

The nitrogen compound is preferably melamine, melamine derivatives of cyanuric acid, melamine derivatives of isocyanuric acid, melamine salts such as melamine phosphate or melamine diphosphate, melamine polyphosphate, dicyandiamide, allantoin, glycoluril or a guanidine compound such as guanidine carbonate, guanidine phosphate, guanidine sulfate, benzoguanamine and/or condensation products of ethyleneurea and formaldehyde and/or comprises ammonium polyphosphate.

In addition to those mentioned above, the nitrogen compound used can comprise oligomeric esters of tris(hydroxyethyl) isocyanurate with aromatic polycarboxylic acids, as described in EP-A 584 567, and nitrogen-containing phosphates of the formulae (NH₄)_{y}H_{3-y}PO₄ and (NH₄PO₃)_{z}, where y can adopt numerical values from 1 to 3 and z is a number of any size (for instance from 1 to 10 000), typically also represented as the average value of a chain length distribution.

The flame-retardant thermoset compositions of the invention preferably comprise from 0.1 to 30 parts by weight of at least one phosphinic salt of the formula (I) and/or one diphosphinic salt of the formula (II) and/or polymers of these, and from 0.1 to 100 parts by weight of inorganic phosphorus compound, and from 0.1 to 100 parts of a nitrogen compound, per 100 parts by weight of thermoset composition.

The flame-retardant thermoset compositions of the invention particularly preferably comprise from 1 to 15 parts by weight of at least one phosphinic salt of the formula (I) and/or one diphosphinic salt of the formula (II) and/or polymers of these, and from 1 to 20 parts by weight of inorganic phosphorus compound, and from 1 to 20 parts of a nitrogen compound, per 100 parts by weight of thermoset composition.

The inorganic phosphorus compound is preferably red phosphorus, ammonium phosphate, and/or melamine phosphate.

The flame-retardant thermoset compositions of the invention preferably also comprise carbodiimides.

The invention further relates to flame-retardant thermoset compositions which are molding compositions, coatings or laminates made from thermoset resins.

The thermoset resins are preferably unsaturated polyester resins or epoxy resins.

The invention further relates to a process for preparing flame-retardant thermoset compositions, which comprises mixing a thermoset resin with a flame retardant made from at least one phosphinic salt of the formula (I) and/or a diphosphinic salt of the formula (II) and/or polymers of these with at least one synergistic component from the substance class of the organic or inorganic phosphorus compounds, and at least one synergistic component from the substance class of the nitrogen compounds, and wet-pressing (cold-pressing) the resultant mixture at pressures of from 3 to 10 bar and at temperatures of from 20 to 80° C.

The invention further relates to a process for preparing flame-retardant thermoset compositions, which comprises mixing a thermoset resin with a flame retardant made from at least one phosphinic salt of the formula (I) and/or a diphosphinic salt of the formula (II) and/or polymers of these with at least one synergistic component from the substance class of the organic or inorganic phosphorus compounds, and at least one synergistic component from the substance class of the nitrogen compounds and wet-pressing (warm- or hot-pressing) the resultant mixture at pressures of from 3 to 10 bar and at temperatures of from 80 to 150° C.

Another process for preparing flame-retardant thermoset compositions according to the present invention comprises mixing a thermoset resin with a flame retardant made from at least one phosphinic salt of the formula (I) and/or a diphosphinic salt of the formula (II) and/or polymers of these with at least one synergistic component from the substance class of the organic or inorganic phosphorus compounds, and at least one synergistic component from the substance class of the nitrogen compounds, and processing the resultant mixture at pressures of from 50 to 150 bar and at temperatures of from 140 to 160° C. to give prepregs.

Finally, the invention also relates to the use of the novel flame-retardant combination for rendering thermoset compositions flame-retardant. The thermoset compositions are preferably unsaturated polyester resins or epoxy resins, and are preferably molding compositions, coatings or laminates.

The salts of the phosphinic acids, as used according to the invention, may be prepared by known methods as described in more detail, for example, in EP-A-0 699 708.

As set out in the examples below, it has been shown that organic or inorganic phosphorus compounds, such as ammonium polyphosphate, and phosphinic salts of the formula (I) and, respectively, (II) do not have sufficient activity when tested by themselves.

Surprisingly, it has now been found that a combination of phosphinic salts and organic or inorganic phosphorus compounds is suitable for achieving the best material classification, V-0, in the UL 94 vertical test in thermosets.

The compounds used in the examples are as follows:

®Alpolit SUP 403 BMT (Vianova Resins GmbH, Wiesbaden, Germany): unsaturated polyester resin, about 57% strength in styrene, acid number not more than 30 mg KOH/g, preaccelerated and formulated to be slightly thixotropic, low viscosity (viscosity from a 4 mm flow cup: 110 ±10 s) and greatly reduced styrene emission.

®Palatal 340 S (DSM-BASF Structural Resins, Ludwigshafen, Germany): unsaturated polyester resin, about 49% strength in styrene and methyl methacrylate, density 1.08 g/ml, acid number 7 mg KOH/g, preaccelerated, low viscosity (dynamic viscosity about 50 mPa*s).

®Beckopox EP 140 (Vianova Resins GmbH, Wiesbaden, Germany): low-molecular-weight condensation product from bisphenol A and epichlorohydrin with a density of 1.16 g/ml and an epoxy equivalent of from 180 to 192

®Beckopox EH 625 (Vianova Resins GmbH, Wiesbaden, Germany): modified aliphatic polyamine with an active hydrogen equivalent weight of 73 and a dynamic viscosity of about 1000 mPa*s.

Cobalt accelerator NL 49P (Akzo Chemie GmbH, Düren, Germany):
cobalt octoate solution in dibutyl phthalate with a cobalt content of 1% by weight.

Cobalt accelerator NL 63-10S (Akzo Chemie GmbH, Düren, Germany).

Butanox M 50 (Akzo Chemie GmbH, Düren, Germany): methyl ethyl ketone peroxide phlegmatized with dimethyl phthalate—clear liquid with a content of at least 9% by weight of active oxygen.

DEPAL: aluminum salt of diethylphosphinic acid.

Preparation of Test Specimens

The thermoset resin and the flame retardant components, and also, if desired, other additives are mixed homogeneously using a dissolver disk. Homogenization is repeated after adding the curing agent.

In the case of unsaturated polyester resins, the resin is mixed with the cobalt accelerator, the flame retardant components are added and the curing is initiated by adding the peroxide after homogenization.

In the case of epoxy resins, the flame retardant components are added to the epoxy resin component and mixed homogeneously. The amine hardener or, respectively, the anhydride hardener is then added.

Two layers of continuous-strand glass-fiber mat of 450 g/m² weight per unit area, on a ®Hostaphan release film and a steel frame, are placed in a heated press. About half of the resin-flame-retardant mixture is then uniformly distributed. Another glass mat is then added and then the remaining resin-flame-retardant mixture is distributed, the laminate is covered with a release film and a pressed sheet of 4 mm thickness is produced at a temperature of 50° C. during a period of one hour at a pressure of 10 bar.

The fire performance testing was carried out according to the Underwriters Laboratories “Test for Flammability of Plastics Materials—UL 94” specification, in the May 2, 1975 edition, using specimens of length 127 mm, width 12.7 mm and various thicknesses.

The determination of oxygen index was based on ASTM D 2863-74, using a modified apparatus.

1. Results with Unsaturated Polyester Resins

Table 1 shows comparative examples with sole and combined used of organic or inorganic compounds of phosphorus and nitrogen and DEPAL as flame-retardant for an unsaturated polyester resin (Viapal UP 403 BMT). The table shows that neither sole use of a concentration of up to 25 parts/100 parts of unsaturated polyester resin nor the use of a combination of phosphorus compounds at 20 parts/100 parts of resin can achieve V-0 classification.

When DEPAL is combined with organic or inorganic compounds of phosphorus or of nitrogen, a V-0 classification is achievable with a laminate thickness of 1.5 mm with a total of as little as 15 parts per 100 parts of resin. The laminates may be colored as desired.

THese UP resin laminates can be produced by the injection process, since the filler content is low.

TABLE 1
(Comparative Examples):
Fire performance of unsaturated polyester resin laminates to UL 94, 30%
by weight of continuous-strand glass-fiber mat, laminate thickness 1.5
mm, Viapal UP 403 BMT resin, Butanox M50 hardener, NL 49 P
accelerator

| Example | Parts of flame | UL 94 | |
|---|---|---|---|
| No. | retardant/100 parts resin | classiflcation | LOI |
| 1 | 25 DEPAL* | n.c. | 0.33 |
| 2 | 25 triethyl phosphate | n.c. | 0.28 |
| 3 | 25 melamine polyphosphate | n.c. | 0.30 |
| 4 | 10 DEPAL + 10 triethyl phosphate | V-1 | 0.38 |
| 5 | 10 DEPAL + 10 melamine | V-0 | 0.42 |
| | polyphosphate | | |
| 6 | 26 melamine | n.c. | 0.23 |
| 7 | 75 melamine | n.c. | 0.23 |
| 8 | 10 DEPAL + 20 melamine | n.c. | 0.23 |
| 9 | 5 DEPAL + 5 tilethyl phosphate + | V-0 | 0.38 |
| invention | 5 melamine | | |
| 10 | 5 DEPAL + 5 melamine | V-0 | 0.43 |
| invention | polyphosphate + 5 melamine | | |

**DEPAL = aluminum salt of diethylphosphinic acid
n.c. = not classifiable in the vertical UL 94 test

2. Results with Epoxy Resins

Table 2 shows fire tests using a polyamine-cured epoxy resin (Beckopox EP 140 resin, Beckopox EH 625 hardener). By combining DEPAL with organic or inorganic compounds of phosphorus or of nitrogen, V-0 classification is achieved at a laminate thickness of 1.5 mm, In contrast, UL 94 V-0 is not achieved, or is achieved only with higher filler levels, using the compounds on their own.

TABLE 2
Fire performance of epoxy resin moldings to UL 94, material thickness
1.6 mm, resin 100 parts of Beckopox EP 140, hardener 39 parts of
Beckopox EH 625

| Example | Parts flame retardant/ | UL 94 | |
|---|---|---|---|
| No. | 100 parts resin | classification | LOI |
| 11 | 10 DEPAL | n.c | 0.27 |
| 12 | 20 DEPAL | V-1 | 0.32 |
| 13 | 25 triethyl phosphate | n.c. | 0.25 |
| 14 | 25 melamine polyphosphate | V-1 | 0.39 |
| 15 | 10 DEPAL + 10 triethyl phosphate | V-0 | 0.41 |
| 16 | 10 DEPAL + 10 melamine | V-0 | 0.40 |
| | polyphosphate | | |
| 17 | 25 melamine | n.c. | 0.22 |
| 18 | 75 melamine | n.c. | 0.21 |
| 19 | 10 DEPAL + 20 melamine | n.c. | 0.26 |
| 20 | 5 DEPAL + 5 triethyl phosphate + 5 | V-0 | 0.30 |
| invention | melamine | | |
| 21 | 5 DEPAL + 5 melamine | V-0 | 0.33 |
| invention | polyphosphate + 5 melamine | | |

1. A flame-retardant thermoset composition comprising a flame retardant selected from the group consisting of a phosphinic salt of the formula (I), a diphosphinic salt of the formula (II), a polymer of the phosphinic salt of the formula (II), a Polymer of the diphosphinic salt of the formula (II) and mixtures thereof, 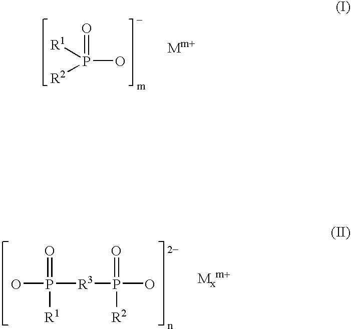
where
R¹,R² are identical or different and are C₁-C₆-alkyl, linear or branched, or aryl;
R³ is C₁-C₁₀-alkylene, linear or branched, C₆-C₁₀-arylene, -alkylarylene or -arylalkylene;
M is Mg, Ca, Al, Sb, Sn, Ge, Ti, Zn, Fe, Zr, Ce, Bi, Sr, Mn, Li, Na, K or a protonated nitrogen base;
m is from 1 to 4;
n is from 1 to 4; and
x is from 1 to 4,
and at least one first synergistic component selected from the group consisting of organic and inorganic phosphorus compounds, and at least one second synergistic component, wherein the at least one second synergistic component is a nitrogen compound.

2. A flame-retardant thermoset composition as claimed in claim 1, wherein R¹ and R² are identical or different and are C₁-C₆-alkyl, linear or branched, or phenyl.

3. A flame-retardant thermoset composition as claimed in claim 1, wherein R¹ and R² are identical or different and are methyl, ethyl, n-propyl, isopropyl, n-butyl, tert-butyl, n-pentyl or phenyl.

4. A flame-retardant thermoset composition as claimed in claim 1, wherein R³ is methylene, ethylene, n-propylene, isopropylene, n-butylene, tert-butylene, n-pentylene, n-octylene or n-dodecylene.

5. A flame-retardant thermoset composition as claimed in claim 1, wherein R³ is phenylene or naphthylene.

6. A flame-retardant thermoset composition as claimed in claim 1, wherein R³ is methylphenylene, ethylphenylene, tert-butylphenylene, methylnaphthylene, ethylnaphthylene or tert-butylnaphthylene.

7. A flame-retardant thermoset composition as claimed in claim 1, wherein R³ is phenylmethylene, phenylethylene, phenylpropylene or phenylbutylene.

8. A flame-retardant thermoset composition as claimed in claim 1, comprising from 0.1 to 30 parts by weight the flame retardant, from 0.1 to 100 parts by weight of the at least one first synergistic component, wherein the at least one first synergistic component is an organic phosphorus compound, and from 0.1 to 100 parts by weight of the nitrogen compound, per 100 parts by weight of the thermoset composition.

9. A flame-retardant thermoset composition as claimed in claim 1, comprising from 1 to 15 parts by weight of the flame retardant, from 1 to 20 parts by weight of the at least one first synergistic component, wherein the at least one first synergistic component is an organic phosphorus compound, and from 1 to 20 parts by weight of the nitrogen compound, per 100 parts by weight of the thermoset composition.

10. A flame-retardant thermoset composition as claimed in claim 1, wherein the—at least one first synergistic component is an organic phosphorus compound selected from the group consisting of triethyl phosphate, triaryl phosphates, tetraphenyl resorcinaldiphosphate, dimethyl methylphosphonate, dimethyl methylphosphonate polymers with phosphorus pentoxide, phosphonate ester, (5-ethyl-2-methyl-dioxaphosphorinan-5-yl)methyl methyl methanephosphonate, phosphoric ester, pyrophosphoric ester, alkylphosphonic acids and oxalkylated derivatives of alkylphosphonic acids.

11. A flame-retardant thermoset composition as claimed in claim 1, wherein the nitrogen compound is melamine, melamine derivatives of cyanuric acid, melamine derivatives of isocyanuric acid, melamine salts, melamine polyphosphate, melamine diphosphate, dicyandiamide, a guanidine compound condensation products of ethyleneurea and formaldehyde, or ammonium polyphosphate.

12. A flame-retardant thermoset composition as claimed in claim 1, comprising from 0.1 to 15 parts by weight of the flame retardant, from 0.1 to 100 parts by weight of the at least one first synergistic component, wherein the at least one first synergistic component is an inorganic phosphorus compound, and from 0.1 to 100 parts by weight of the nitrogen compound, per 100 parts by weight of the thermoset composition.

13. A flame-retardant thermoset composition as claimed in claim 1, comprising from 1 to 15 parts by weight of the flame retardant, from 1 to 20 parts by weight of the at least one first synergistic component, wherein the at least one synergistic component is an inorganic phosphorus compound, and from 1 to 20 parts by weight of the nitrogen compound, per 100 parts by weight of the thermoset composition.

14. A flame-retardant thermoset composition as claimed in claim 1, wherein the at least one first synergistic component is an inorganic phosphorus compound selected from the group consisting of red phosphorus, ammonium phosphate and melamine polyphosphate.

15. A flame-retardant thermoset composition as claimed in claim 1, further comprising at least one carbodiimide.

16. A flame-retardant thermoset composition as claimed in claim 1, wherein the thermoset composition is selected from the group consisting of a molding composition, a coating and a laminate made from thermoset resins.

17. A flame-retardant thermoset composition as claimed in claim 16, wherein the thermoset resins are unsaturated polyester resins or epoxy resins.

18. A process for preparing flame-retardant thermoset compositions as claimed in claim 1, comprising the steps of mixing a thermoset resin with the flame retardant, the at least one first synergistic component and the at least one second synergistic component to form a mixture, and wet-pressing the mixture at a pressure of from 3 to 10 bar and at temperatures a of from 20 to 60° C.

19. A process for preparing flame-retardant thermoset compositions as claimed claim 1, comprising the steps of mixing a thermoset resin with the flame retardant, the at least one first synergistic component, and the at least one second synergistic component to form a mixture, and wet-pressing the mixture at a pressure of from 3 to 10 bar and at a temperature of from 80 to 150° C.

20. A process for preparing flame-retardant thermoset compositions as claimed in claim 1, comprising the steps of mixing a thermoset resin with the flame retardant, at least one first synergistic component, and at least one second synergistic component to form a mixture, and processing the mixture at a pressure of from 50 to 150 bar and at a temperature of from 140 to 160° C. to give prepregs.

21. A flame-retardant thermoset composition as claimed in claim 11, wherein the melamine salt is melamine phosphate.

22. A flame retardant thermoset composition as claimed in claim 11, wherein the guanidine compound is selected from the group consisting of guanidine carbonate, guanidine phosphate and guanidine sulfate.

23. The process as claimed in claim 18, wherein the wet pressing step further comprises cold pressing.

24. The process as claimed in claim 19, wherein the wet pressing step further comprises warm or hot pressing.
